(19) United States
(12) Patent Application Publication
(10) Pub. No.: US 2006/0159024 A1
(43) Pub. Date: Jul. 20, 2006

(54) Method and apparatus for responding to node anormalities within an ad-hoc network

(76) Inventor: Lance E. Hester, Sunrise, FL (US)

Correspondence Address: MOTOROLA, INC., 1303 EAST ALGONQUIN ROAD, IL01/3RD, SCHAUMBURG, IL, 60196, US

(21) Appl. No.: 11/038,650

(22) Filed: Jan. 18, 2005

(51) Int. Cl. H04J 3/14

(52) U.S. Cl. 370/242

(57) ABSTRACT

A method and apparatus for responding to node failures within an ad-hoc network is provided herein. In particular, an ad-hoc network (300) is provided that analyzes a type of network failure, and operates as either a random network or a scale-free network in response to the node failure. The ad-hoc network provided herein will adjust from one topology to another as environmental conditions dictate. Thus, the survivability of a network is increased in the event of either node failures or dedicated attacks.

### FIELD OF THE INVENTION

The present invention relates generally to ad-hoc networks, and in particular, to a method and apparatus for responding to node abnormalities within an ad-hoc network.

### BACKGROUND OF THE INVENTION

Many ad-hoc networks are highly clustered, having small network diameters. Such a network is shown in FIG. 1. As shown, a plurality of hubs (or coordinators) 102 exist, with all communication between nodes 101 and 102 passing through at least one coordinator or not more than 2 logical hops from a coordinator. It should be noted that although not shown, in scale free networks, most nodes are connected (1-hop) to a coordinator, but they do not necessarily have to be. In some cases, a node may have to connect to a node already connected to a coordinator. Such networks are considered “scale-free” where there is no “scale” or average number of links between devices or nodes. Several nodes have a few links, while a small number of nodes have many links. The number of links versus the number of nodes follows a power law distribution (see FIG. 1).

In contrast, random networks or graphs (shown in FIG. 2) do not have highly connected nodes 101, and it is not necessary for communication to pass through any single device (such as a coordinator). Here, nodes have a small number of connections lingering around a small average value or what is known as a “scale”. As shown in FIG. 2, the number of links versus the number of nodes follows a Gaussian/bell curve like distribution, where the peak of the bell curve gives the average number of links per node. As a random graph network grows, the relative number of very connected nodes decreases.

A major difference between scale-free and random networks is in how they respond to node failures, or abnormal operation. The connectedness of a random network decays steadily as random nodes fail, slowly partitioning the network. Scale-free networks show little degradation as random nodes fail. It takes several random failures before hubs 102 are wiped out, and only then does a network stop working. Of course, there is the possibility that a hub is one of the first nodes to go, but statistically this is a rarity. Conversely, scale-free networks suffer most from dedicated attacks. If a large degree node is strategically attacked the whole network suffers. Random networks are resilient to dedicated attacks. It would be beneficial if an ad-hoc network could have the robustness of scale-free networks to random node failures and additionally have the robustness of random networks to dedicated attacks. Therefore, a need exists for a method and apparatus for responding to node failures within an ad-hoc network that provides robustness of scale-free networks to random node failures and additionally has the robustness of random networks to dedicated attacks.

### BRIEF DESCRIPTION OF THE DRAWINGS

FIG. 1 shows an ad-hoc network operating with a scale-free topology.

FIG. 2 shows an ad-hoc network operating with a random topology.

FIG. 3 illustrates a random distribution of nodes.

FIG. 4 illustrates a scale-free topology for the node distribution of FIG. 3.

FIG. 5 illustrates a random topology for the node distribution of FIG. 3.

FIG. 6 is a flow chart showing operation of the network of FIG. 3.

FIG. 7 is a block diagram of a node.

FIG. 8 is a flow chart showing operation of the node of FIG. 7.

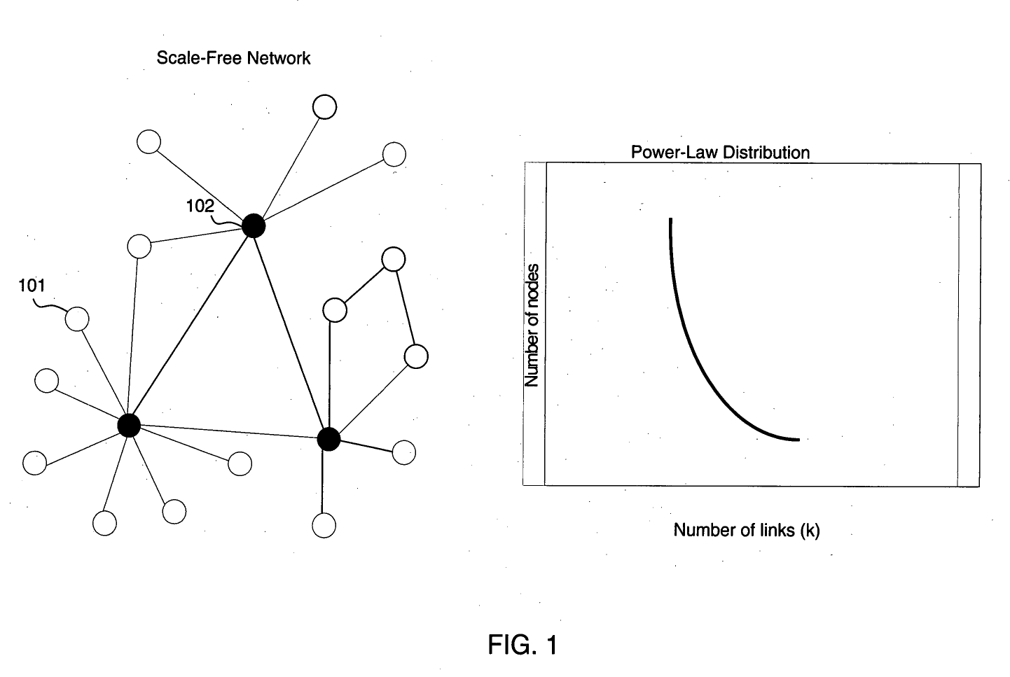

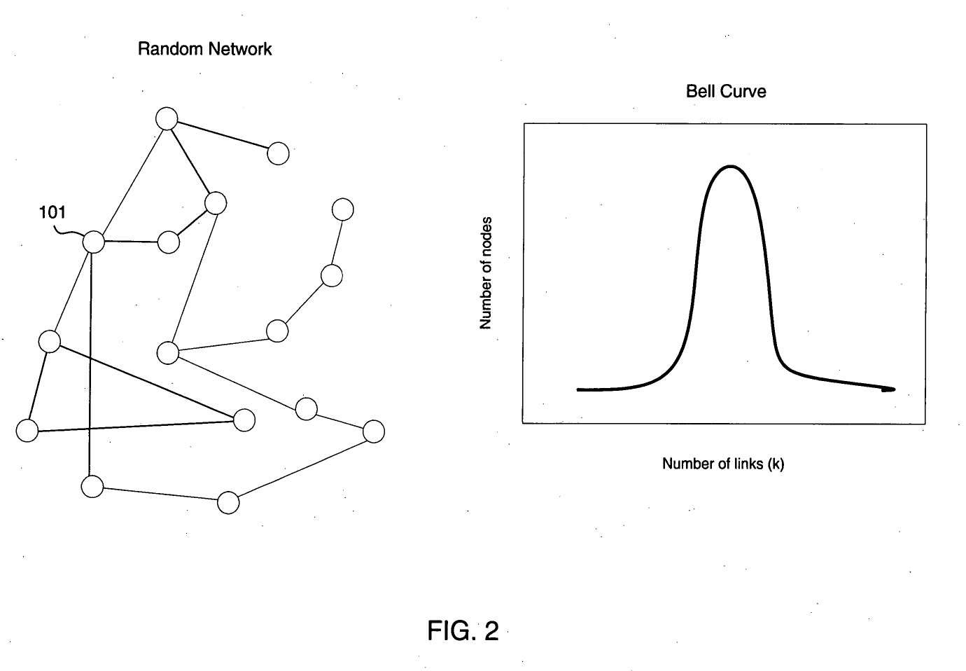

### DETAILED DESCRIPTION OF THE DRAWINGS

To address the above-mentioned need a method and apparatus for responding to node failures within an ad-hoc network is provided herein. In particular, an ad-hoc network is provided that analyzes a type of network failure, and operates as either a random network or a scale-free network in response to the node failure. The ad-hoc network provided herein will adjust from one topology to another as environmental parameters dictate. Thus, the survivability of a network is increased in the event of either node failures or dedicated attacks.

The present invention encompasses a method for responding to node abnormalities within an ad-hoc network. The method comprises the steps of analyzing an environment for abnormal node operation, determining that abnormal node operation is taking place, and instructing the ad-hoc network to change from a first topology to a second topology in response to the determination.

The present invention additionally encompasses a method for responding to node abnormalities within an ad-hoc network. The method comprises the steps of analyzing an environment for abnormal node operation, determining that abnormal node operation is taking place, determining if a topology change is desired, and instructing the ad-hoc network to change from a first topology to a second topology if the topology change is desired.

Finally, the present invention encompasses an apparatus comprising logic circuitry for analyzing an environment for abnormal node operation, determining that abnormal node operation is taking place, and instructing the ad-hoc network to change from a first topology to a second topology in response to the determination.

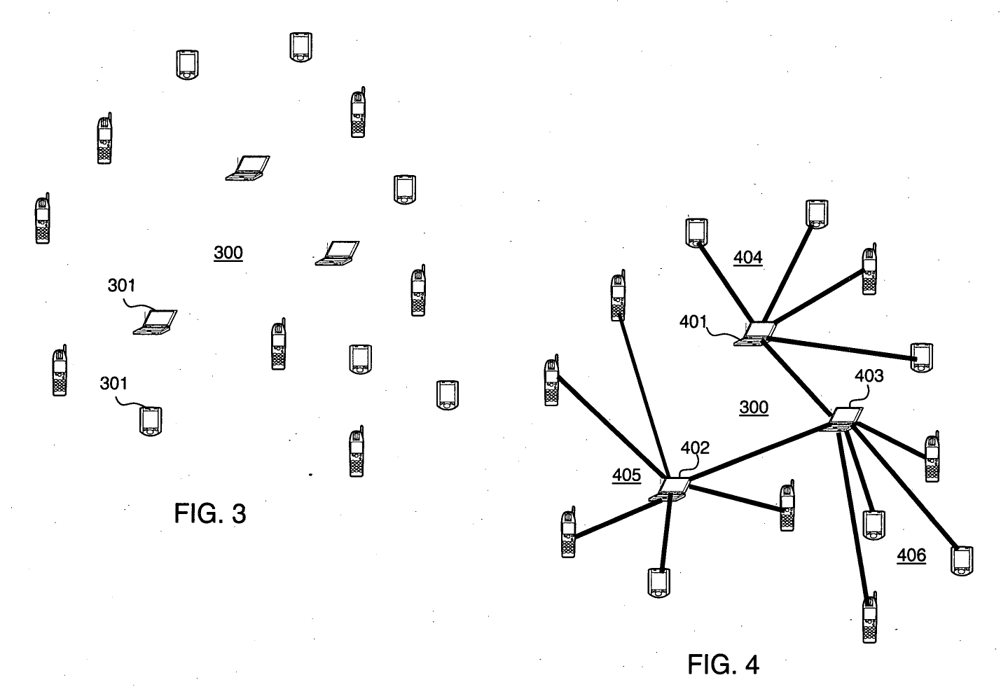

Turning now to the drawings, wherein like numerals designate like components, FIG. 3 shows a random distribution of nodes 301 (only two labeled). Nodes 301 comprise wireless devices (stationary or mobile) that can include, for example, transceiver security tags, lap top computers, personal digital assistants, or wireless communication devices including cellular telephones. The collection of nodes 301 makes up a network 300 which can be configured to operate via one of several known topologies (e.g., a scale-free-network, a random network, a spanning tree, . . . , etc.). In the preferred embodiment of the present invention, network 300 can be configured to operate as either a scale-free network or as a random network.

During operation as a scale-free network (shown in FIG. 4), network 300 comprises a plurality of hubs, or piconet controllers 401-403, each forming its own cluster or piconet of devices 404-406. When operating in a scale-free topology, network 300 utilizes a modified neuRFon™ system protocol as described in U.S. patent application Ser. No. 09/803259. It should be noted that although in the preferred embodiment a neuRFon™ system protocol is utilized, in alternate embodiments of the present invention other scale-free system protocols might be used. Such protocols include, but are not limited to the Motorola Canopy™ system protocol, the ZigBee Alliance™ system protocol, WPAN formation protocols, mesh networks, and hybrid wireless network protocols, etc.

As is evident, all communication will pass through at least one controller 401-403. Piconet controllers 401-403 are responsible for timing and synchronization of the devices within its piconet, for assigning unique piconet network addresses, for routing messages, for broadcasting device discovery and service discovery information, and possibly for power control. Each piconet controller 401-403 can have up to a maximum number (Cₘ) of children nodes under it. In a similar manner, each child node can serve as its own piconet controller and have up to Cₘ child nodes. Thus, for example, in FIG. 4, where Cₘ=5, controller 401 has five child nodes (including node 403). In a similar manner, child node 403 serves as a controller to five nodes (including node 402).

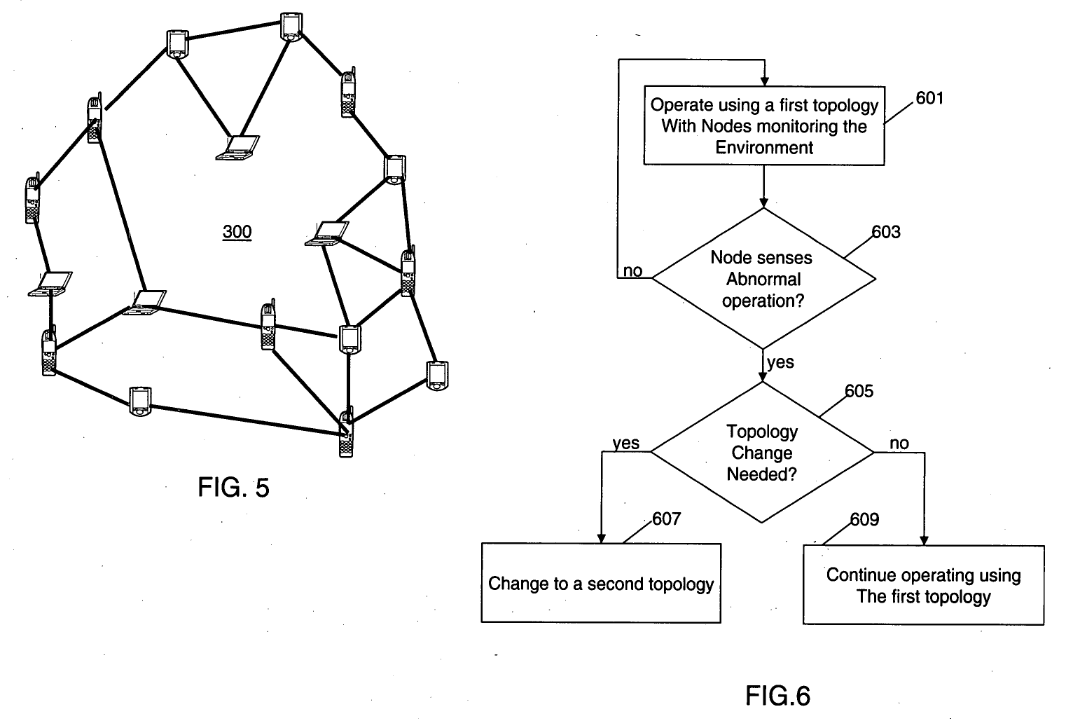

During operation as a random network (shown in FIG. 5) each node is capable of direct communication with any other node in network 300. When operating in a random topology, network 300 utilizes a modified mesh-type system topography as described in the IEEE 802.11 ad-hoc networking protocols. In alternate embodiments, network 300 may utilize other communication system protocols, such as, but not limited to a WLAN network or a Rooftop™ Wireless Routing mesh network manufactured by Nokia, Inc. As discussed above, nodes within a random network have a small number of connections lingering around a small average value or what is known as a “scale”. The number of links versus the number of nodes follows a Gaussian/bell curve like distribution, where the peak of the bell curve gives the average number of links per node. As a random graph network grows, the relative number of very connected nodes decreases.

As discussed, scale-free networks show little degradation as random nodes fail, but suffer most from dedicated attacks. Additionally, random networks are resilient to dedicated attacks. With this in mind, network 300 is configured to operate utilizing either a scale-free topology or a random topology as environmental parameters dictate, switching between the two topologies. More particularly, an ad-hoc network exhibiting random network typology will change to an ad-hoc network having a scale-free topology when random nodes fail. Likewise, an ad-hoc network exhibiting scale-free network typology will change to an ad-hoc network having a random topology when a dedicated attack on a node is sensed.

During operation, a node will analyze the environment for abnormal node operation. In the preferred embodiment of the present invention, the radio environment is analyzed to determine if a dedicated attack and/or random node failures are occurring. Such operating parameters as energy, routing tables, data buffers, missed packets, and authentication lists are analyzed. A node may recognize that network 300 is suffering from abnormal operation such as random node failures or a dedicated attack. A dedicated attack could be, for example, the jamming of a node, a buffer overflow, a host impersonation/Sybil attack, . . . , etc. One possible way for a node to distinguish an “attack” from a “failure” is to monitor if the abnormally operating node is being bombarded with constant energy from an attacker, jamming transmissions. Here, constant transmissions would prevent nodes form exchanging data or even reporting the attack. A lack of response (like in the case of a failure without monitoring constant energy) would indicate a node failure and not an attack. A node would recognize a buffer overflow attack, by monitoring how quickly and frequently its routing table is filled with unwanted routing entries or how its data packet buffer space is consumed with unwanted data. Host impersonation/Sybil attacks, where attackers present themselves as different nodes or multiple nodes are detected via encryption and authentication measures like security keys or access control lists. Node failure is readily noticed by unacknowledged packet receptions like no longer receiving beacon update messages or replies to data requests, continual message retransmissions because a node in path between a source and destination has failed, or pre-emptive low battery indication messages warning of future node failure.

Depending on the current topology (mode of operation) and depending upon the type of node failures, the node may instruct network 300 to change topologies. The node must determine if a topology change is desired. For example, if network 300 is currently operating in a scale-free topology and a node senses a dedicated attack, the node will instruct all nodes in network 300 to change topologies to a random topology. Table 1 shows the action taken by network 300 for various topologies and attacks.

TABLE 1
Action taken by network 300 for various sensed conditions.

| Current Topology | Sensed Condition | Operate As |
|---|---|---|
| Scale-Free | Dedicated Attack | Random |
| Scale-Free | Node Failure | Scale-Free |
| Random | Dedicated Attack | Random |
| Random | Node Failure | Scale-Free |

FIG. 6 is a flow chart showing operation of the network of FIG. 3. The logic flow begins at step 601 where network 300 is operating using a first topology (e.g., scale-free or random) with nodes continuously monitoring their environment. As discussed above, nodes within network 300 preferably monitor any combination of energy, routing tables, data buffers, missed packets, and/or authentication lists. At step 603 all nodes determine if an abnormality was sensed. For example, nodes may determine that a dedicated attack is occurring, or may sense that random nodes are failing. If, at step 603 any node determines that an abnormality has occurred, the logic flow continues to step 605, otherwise the logic flow returns to step 601. At step 605 the node that sensed the environmental change determines if a topology change is needed, and if so, the logic flow continues to step 607 where the topology is changed to a second topology, otherwise the logic flow continues to step 609 where network 300 continues operating using the first topology.

During topology changes, network 300 switches from a scale-free topology to a random topology, or vice versa. When changing from a random topology to a scale-free topology the node that sensed the environmental change will solicit a neighboring node to become a controller. The node sends a “CONTROLLER SOLICITATION” message to the potential candidate controller node asking it to take on the role of a controller. The controller candidate will respond back with a positive or negative acknowledgement based on a) its desire to cooperate as a controller and b) after performing some controller mitigation test to ensure that it will not cause a controller overlap or conflict. This mitigation test would involve checking its neighbor table to see if one of its two hop neighbors is already a controller. If the node agrees to become a controller, and the controller mitigation test did not result in any conflicts, it responds with an affirmative acknowledgement and will subsequently flood a 2 hop time to live (TTL) message announcing that it is operating as a controller to all of its neighbors.

Once a controller has been established, neighboring nodes that are within 1-hop transmission range to the controller will prioritize the link between themselves and the controller to be their main communication link. They will still maintain a table of other links to other nodes, but there first choice for communication will be with the controller nodes. Nodes maintain these other links for network recovery in the case of faults and more importantly to quickly revert back to a pre-existing topology should the controller node abandon its controller status for any reason.

Although not shown in the figures, when switching from say a random network to scale-free network; the network may create short cut routes for the purposes of delivering short message transactions and resource discovery queries that result in better message throughput.

Should the nodes in the network decide to revert from a scale-free network to a random network configuration, the above-processes would happen in reverse. First, a controller would alert its neighbors via a reduced 2-hop flood of “RELIQUISHNG CONTROLLER STATUS” messages of its desire to stop acting as a controller. At this point, the controller node could solicit another node to take its place as a controller. The neighbor nodes would acknowledge this relinquish message. After waiting for an appropriate period of time (4 times the two hop message propagation). The controller node will resume normal node status. The neighboring nodes will reprioritize their communication links because the link to the controller will no longer be their primary communication link.

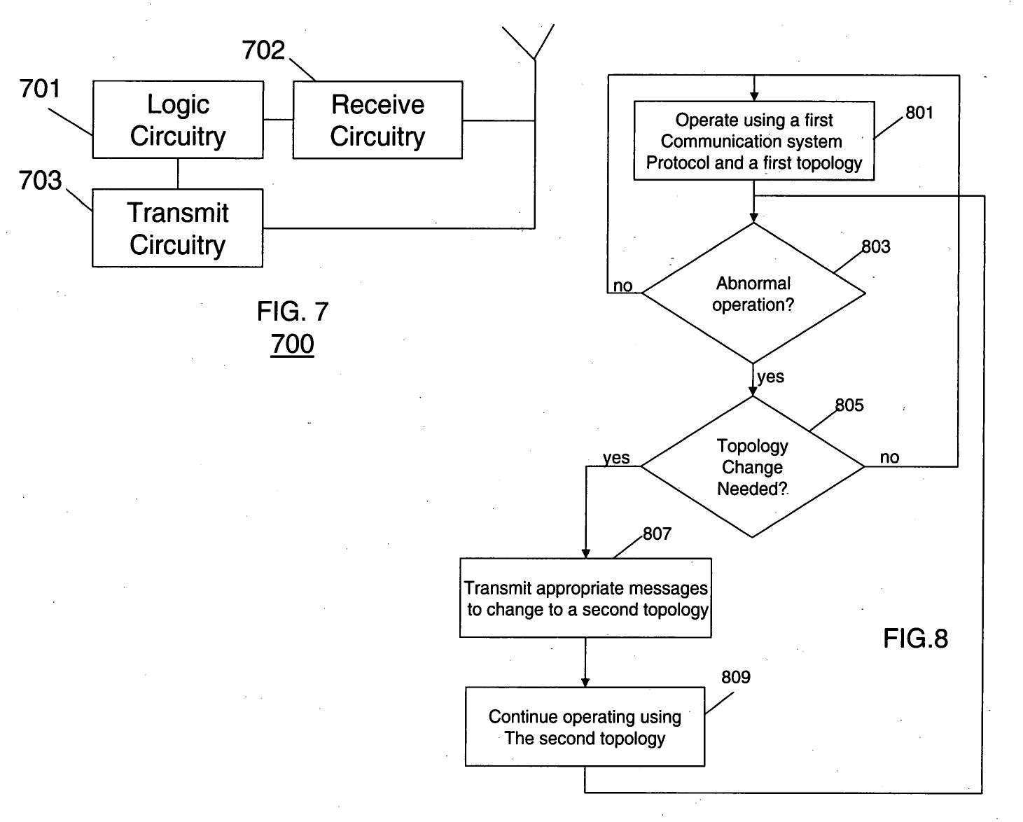

FIG. 7 is a high-level block diagram of a node. In the preferred embodiment of the present invention all nodes within communication system 300 contain the elements shown in node 700. As shown, node 700 comprises logic circuitry 701, receive circuitry 702, and transmit circuitry 703. Logic circuitry 701 preferably comprises a microprocessor controller, such as, but not limited to a Motorola PowerPC microprocessor. In the preferred embodiment of the present invention logic circuitry 701 serves as means for controlling node 700, and as means for analyzing environmental parameters to determine any actions needed. Additionally receive and transmit circuitry 702-703 are common circuitry known in the art for communication utilizing a well-known communication protocol, and serve as means for transmitting and receiving messages. For example, when utilizing a scale-free topology, receiver 702 and transmitter 703 are well known neuRFon™ transmitters that utilize the neuRFon™ communication system protocol. Other possible transmitters and receivers include, but are not limited to transceivers utilizing Bluetooth, IEEE 802.11, or HyperLAN protocols.

FIG. 8 is a flow chart showing operation of node 700. The logic flow begins at step 801 with node 700 operating utilizing a first communication system protocol (e.g., neuRFon™, 802.11, . . . , etc.) and a first topology. At step 803, logic circuitry analyzes environmental parameters to determine if abnormal operation is occurring for any node within communication system 300. More particularly, logic circuitry 701 analyzes energy, routing tables, data buffers, missed packets, and authentication lists to determine if any abnormal operation of communication system 300 is occurring. If at step 803 it is determined by logic circuitry 701 that abnormal operation is occurring, the logic flow continues to step 805 where logic circuitry 701 determines if a topology change is needed.

If a topology change is needed at step 805, the logic flow continues to step 807, otherwise the logic flow returns to step 801. At step 807, logic circuitry instructs transmit circuitry to transmit the appropriate messages (as described above) in order to change the topology of communication system 300. Finally, at step 809, node 700 operates utilizing a second communication system protocol and a second topology.

While the invention has been particularly shown and described with reference to a particular embodiment, it will be understood by those skilled in the art that various changes in form and details may be made therein without departing from the spirit and scope of the invention. It is anticipated that communication system 300 may change topologies upon other environmental factors. For example, a node may offer a specific service or have knowledge of how to access a particular service offered by communication system 300. Such services include, but are not limited to remote sensing (biosensing, temperature, moisture, vibration etc.), localization, data retrieval, etc. The node may then volunteer to take on the status of a controller node in order to provide the service to neighboring nodes.

Additionally, a node may change topologies after a pre-established “number of connections” threshold is reached. Reaching this threshold will automatically force a node to vie for controller status. As discussed above when changing to a scale-free topology, a node will perform a controller mitigation test to ensure that it will not cause any controller overlap conflicts. If it passes the controller mitigation test, it transmits a limited flood of “DESIRE TO BECOME A CONTROLLER” messages to all its <=2 hop neighbors. The node then waits to hear any negative acknowledgements from its neighbors as to whether or not it can become a controller for a time period equivalent to 2 times the propagation time needed for a packet to traverse two hops. Barring any negative acknowledgements, the node assumes controller status and will broadcast once again a limited flood verifying that it can now be regarded as a controller and specifying any special services. In the event, the node receives negative acknowledgements. It will discontinue trying to become a controller although, it may retry some time later.

1. A method for responding to node abnormalities within an ad-hoc network, the method comprising the steps of:
analyzing an environment for abnormal node operation;
determining that abnormal node operation is taking place; and
instructing the ad-hoc network to change from a first topology to a second topology in response to the determination.

2. The method of claim 1 further comprising the step of:
determining that a topology change is desired.

3. The method of claim 1 wherein the step of analyzing the environment for abnormal node operation comprises the step of analyzing the environment to determine if random node failures are occurring.

4. The method of claim 1 wherein the step of analyzing the environment for abnormal node operation comprises the step of analyzing the environment to determine if a dedicated attack on a node is occurring.

5. The method of claim 1 wherein the step of analyzing the environment for abnormal node operation comprises the step of analyzing the environment to determine if random node failures and dedicated attacks are occurring.

6. The method of claim 1 wherein the step of analyzing the environment comprises the step of analyzing energy, routing tables, data buffers, missed packets, or authentication lists to determine if abnormal node operation is occurring.

7. The method of claim 1 wherein the step of instructing the ad-hoc network to change from the first topology to the second topology comprises the step of instructing the ad-hoc network to change from a scale-free topology to a random topology.

8. The method of claim 1 wherein the step of instructing the ad-hoc network to change from the first topology to the second topology comprises the step of instructing the ad-hoc network to change from a random topology to a scale-free topology.

9. The method of claim 1 wherein the step of instructing the ad-hoc network to change from the first topology to the second topology comprises the step of instructing the ad-hoc network to change from a scale-free topology utilizing a first communication system protocol to a random topology using a second communication system protocol.

10. A method for responding to node abnormalities within an ad-hoc network, the method comprising the steps of:
analyzing an environment for abnormal node operation;
determining that abnormal node operation is taking place;
determining if a topology change is desired; and
instructing the ad-hoc network to change from a first topology to a second topology if the topology change is desired.

11. The method of claim 10 wherein the step of analyzing the environment for abnormal node operation comprises the step of analyzing the environment to determine if random node failures are occurring.

12. The method of claim 10 wherein the step of analyzing the environment for abnormal node operation comprises the step of analyzing the environment to determine if a dedicated attack on a node is occurring.

13. The method of claim 10 wherein the step of analyzing the environment for abnormal node operation comprises the step of analyzing the environment to determine if random node failures and dedicated attacks are occurring.

14. The method of claim 10 wherein the step of analyzing the environment comprises the step of analyzing energy, routing tables, data buffers, missed packets, or authentication lists to determine if abnormal node operation is occurring.

15. The method of claim 10 wherein the step of instructing the ad-hoc network to change from the first topology to the second topology comprises the step of instructing the ad-hoc network to change from a scale-free topology to a random topology.

16. The method of claim 10 wherein the step of instructing the ad-hoc network to change from the first topology to the second topology comprises the step of instructing the ad-hoc network to change from a scale-free topology utilizing a first communication system protocol to a random topology using a second communication system protocol.

17. The method of claim 10 wherein the step of instructing the ad-hoc network to change from the first topology to the second topology comprises the step of instructing the ad-hoc network to change from a scale-free topology utilizing a first communication system protocol to a random topology using a second communication system protocol, wherein the first communication system protocol is taken from the group consisting of a neuRFon™ system protocol, a Motorola Canopy™ system protocol, a ZigBee system protocol, a WPAN formation protocol, a mesh networks protocol, and a hybrid wireless network protocol.

18. An apparatus comprising:
logic circuitry for analyzing an environment for abnormal node operation, determining that abnormal node operation is taking place, and instructing the ad-hoc network to change from a first topology to a second topology in response to the determination.

19. The apparatus of claim 18 wherein the environment is analyzed to determine if random node failures are occurring.

20. The apparatus of claim 18 wherein the environment is analyzed to determine if a dedicated attack on a node is occurring.
